(19) United States
(12) Patent Application Publication
(10) Pub. No.: US 2010/0107471 A1
(43) Pub. Date: May 6, 2010

(54) TRAP FOR GOPHERS AND UNDERGROUND PESTS

(76) Inventor: RONALDO LORENZO CERVANTES, Albuquerque, NM (US)

Correspondence Address: RONALDO CERVANTES, 7408 Willow Wood Drive NW, Albuquerque, NM, 87120-4038, US

(21) Appl. No.: 12/570,376

(22) Filed: Sep. 30, 2009

Related U.S. Application Data
(60) Provisional application No. 61/111,801, filed on Nov. 6, 2008.

(51) Int. Cl. A01M 23/02

(52) U.S. Cl. 43/60

(57) ABSTRACT

A trap for gophers and underground pests includes: a spring; a catapult attached to the spring having an open position and a closed position and a distal end from the spring, the spring rotating the catapult; a snare for the animal having a size that reduces when the snare is pulled; a snare coupling on the distal end of the catapult, attached to the snare so that the catapult pulls on the snare; a suppression lever to releasably hold the catapult open; a footplate to releasably retain the suppression lever; and an actuator to press upon the footplate in the presence of the animal. The actuator presses upon the footplate, which releases the suppression lever, which releases the catapult to transition from the open position to the closed position, which causes the snare coupling to pull on the snare, which reduces the size of the snare, catching the animal.

### RELATED APPLICATIONS

The present application claims benefit of priority from U.S. Provisional Application No. 61/111,801, filed Nov. 6, 2008, which is incorporated herein by reference in its entirety.

### BACKGROUND OF THE INVENTION

The present invention generally relates to animal traps, and more specifically, to a trap for gophers and underground pests.

Existing traps kill the animals they catch, such as gophers, sometimes in a cruel way.

As can be seen, there is a need for an underground trap to humanely catch gophers.

### SUMMARY OF THE INVENTION

In one aspect of the present invention, a device for catching an animal includes: a spring to apply a rotational force; a catapult attached to the spring, the catapult having an open position and a closed position, the catapult having a distal end from the spring, the spring applying the rotational force to the catapult so that the distal end of the catapult rotates about the spring causing the catapult to transition from the open position to the closed position; a snare for the animal having a size that reduces when the snare is pulled; a snare coupling on the distal end of the catapult, attached to the snare so that when the catapult transitions from the open position to the closed position, the snare coupling pulls on the snare; a suppression lever to releasably hold the catapult in the open position; a footplate to releasably retain the suppression lever; and an actuator to press upon the footplate in the presence of the animal; wherein, in the presence of the animal, the actuator presses upon the footplate, which releases the suppression lever, which releases the catapult to transition from the open state to the closed position, which causes the snare coupling to pull on the snare, which reduces the size of the snare, thereby catching the animal.

In another aspect of the present invention, a device for catching an animal below the ground includes: a generally flat base; a peg receptacle on two sides of the base, to releasably attach the base to the ground; a catapult having an open position and a closed position; a first spring, fixed to the base; a second spring, fixed to the base, in a line with the first spring, the first and second springs adapted to apply a rotational force to the catapult that transitions the catapult from the open position to the closed position; a suppression lever to releasably hold the catapult in the open position; a footplate to releasably retain the suppression lever; an actuator to press upon the footplate in the presence of the animal, a portion of the actuator adapted to extend into the ground; a space between the first spring and second spring to allow the footplate and suppression lever to lie in a line generally parallel to the base and perpendicular to the line of the springs; a snare for the animal having a size that reduces when the snare is pulled, a portion of the snare adapted to extend into the ground; and a snare coupling that pulls on the snare when the catapult transitions from the open position to the closed position; wherein, in the presence of the animal under the ground, the snare catches the animal.

In yet another aspect of the present invention, a method of catching an animal includes: in response to a presence of the animal, utilizing an actuator to press upon a footplate; retaining and releasing a suppression lever with the footplate; retaining and releasing a catapult with the suppression lever; applying a rotational force to the catapult with a spring, thereby transitioning the catapult from an open position to a closed position; when the catapult transitions from the open position to the closed position, pulling upon a snare with the catapult; and reducing the diameter of the snare, thereby catching the animal.

These and other features, aspects and advantages of the present invention will become better understood with reference to the following drawings, description and claims.

### BRIEF DESCRIPTION OF THE DRAWINGS

FIG. 1 depicts a perspective view of an embodiment of the present invention;

FIG. 2 is a top view of an embodiment of the present invention;

FIG. 3 is a front view of an embodiment of the present invention;

FIG. 4 is a side view of an embodiment of the present invention; and

FIG. 5 is an exploded view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a trap for gophers

An embodiment of the present invention may include a platform, a swing arm actuator, a catapult footplate, a catapult suppression stick, a catapult, a curly-Q loop, a snare hoop, a loaded spring, a shepherd peg, a side ring, an L-rod, a wire guide, a swing arm actuator (SAA) hole, a suppression stick hook, and N-staple.

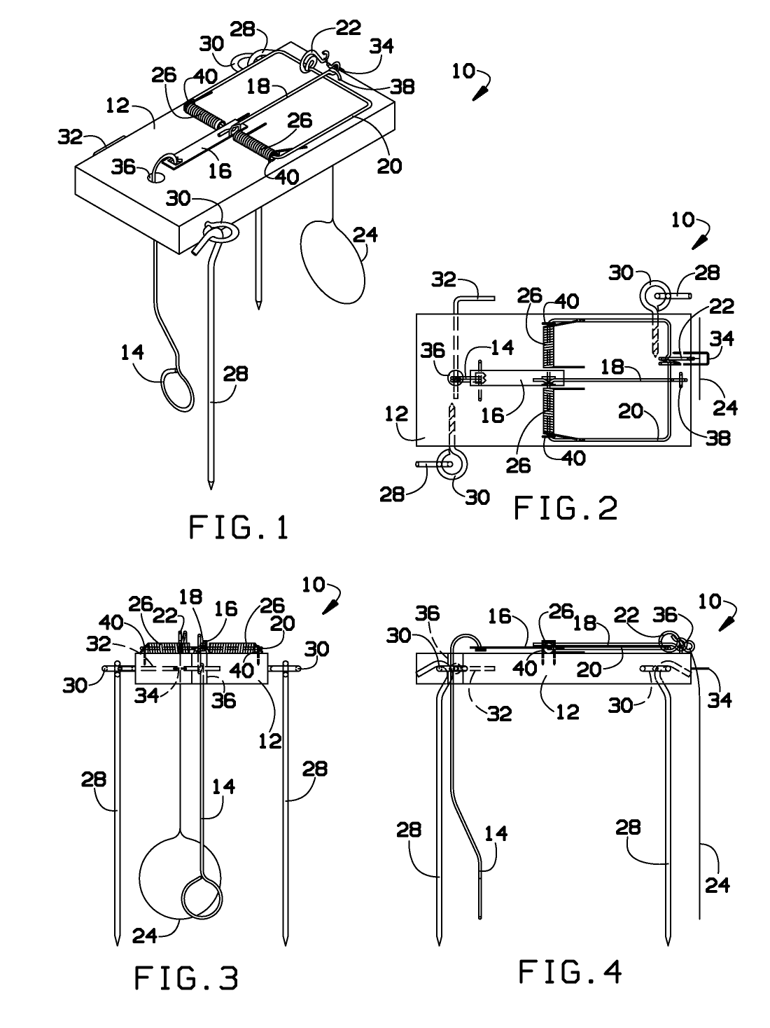

FIG. 1 is a perspective view of an embodiment of the present invention. In this view you see the catapult suppression stick 18, attached to the platform 12 by the suppression stick hook 38, suppressing the catapult 20 by resting on the catapult 20 as the catapult footplate 16 holds it in place. The loaded springs 26 are in the load position, ready to power the catapult 20 from one side of the platform 12 to the other once the swing arm actuator 14 presses down on the catapult foot plate 16 releasing the catapult suppression stick 18 that is then forced out of the way by the catapult 20 as it moves from one end of the platform 12 to the other.

FIG. 2 is a top view of an embodiment of the present invention. The L-rod 32 is inserted into a predrilled hole in the platform 12 that extends to the opposite side of the SAA hole 36. N-staples 40 are used to secure the catapult 20 and loaded springs 26 to the platform 12. The wire guide 34 is used to align the snare hoop 24 and curly-Q loop 22 with the platform 12.

FIG. 3 is a front view of an embodiment of the present invention, including the lower end surface side of both the snare hoop 24 and the swing arm actuator 14. Also shown is their relative position to one another and the platform 12.

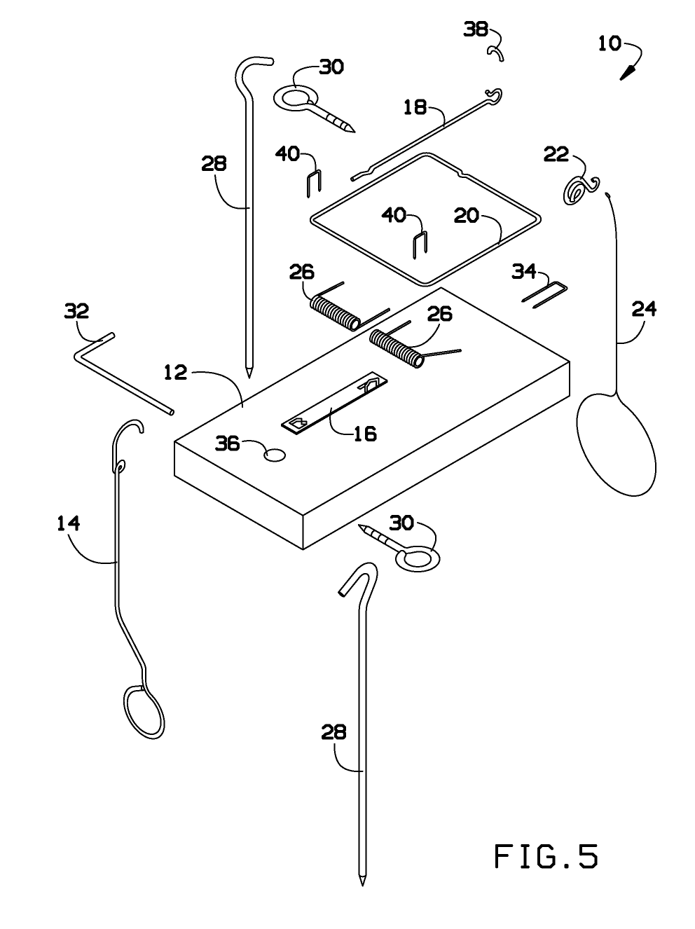

FIG. 4 is a side view of an embodiment of the present invention. The side rings 30 are screwed into the side of the platform 12, and the shepherd pegs 28 are inserted into the side rings 30 for the purpose of holding the platform 12 firmly in place. The curly-Q loop 22 is attached to the catapult 20 and the upper end of the snare hoop 24. The swing arm actuator 14 side profile is also shown, revealing its shape and position.

FIG. 5 is an exploded view of an embodiment of the present invention. The platform 12 allows for each of the remaining elements to be placed in a specified location. The side rings 30 are screwed into the side of the platform 12 through which the shepherd pegs 28, responsible for holding the platform 12 in place, pass through. The two loaded springs 26 are independent of each other and along with the catapult footplate 16, are held to the platform 12 by the catapult 20 that passes through each of them and is itself fastened to the platform 12 by the N-staples 40 or other fastening mechanisms. The L-rod 32 slides into a pre-drilled hole in the side of the platform 12 and is used to hold the swing arm actuator 14, which pivots on the L-rod 32, to the platform 12. The swing arm actuator (SAA) hole 36 allows the swing arm actuator 14 to extend upward through the platform 12, so it can make contact with the catapult footplate 16. The catapult suppression stick 18, secured to the platform 12 by the suppression stick hook 38, suppresses the catapult 20 until it's released by the catapult footplate 16. The wire guide 34 is pressed into the side of the platform 12 and used to align the snare hoop 24 and the curly-Q loop 22 with the platform 12. The snare hoop 24 is attached to the curly-Q loop 22, which is itself hooked to the catapult 20. It should further be noted that the wood platform 12 can be made of other malleable material, including but not limited to plastic. With respect to the wire snare hoop 24, other types of metal wire can be used as well. In regards to the rest of the elements, which are all metal (14, 16, 18, 20, 22, 26, 28, 30, 32, 34, 36, 38, 40), various other rigid material can be substituted.

In an embodiment, when pressure is applied to the bottom end of the swing arm actuator 14, the swing arm actuator 14 pivots on the L-rod 32 causing the top end of the swing arm actuator 14 to press down on the catapult footplate 16 releasing the catapult suppression stick 18, which in turn allows the catapult 20, powered by the loaded springs 26, to swing from one end of the trap to the other, bringing with it, the curly-Q loop 22 that's attached to the top end of the snare hoop 24. Once this occurs, the circumference of the hoop located at the bottom end of the snare hoop 24 is significantly reduced.

Embodiments of the present invention, which may be called “the Gopher Grabber,” may trap gophers in a humane way, allowing for a healthy release back into the wild.

An embodiment of a the present invention may include: a platform 12, a swing arm actuator 14, a catapult footplate 16, a catapult suppression stick 18, a catapult 20, a curly-Q loop 22, a snare hoop 24, a loaded spring 26, a shepherd peg 28, a side ring 30, a L-rod 32, a wire guide 34, a SAA hole 36, a suppression stick hook 38, and an N-staple 40. The side rings 30 are screwed securely into the side of the platform 12, the L-rod 32 is removable, allowing for quick replacement of the swing arm actuator 14, the catapult 20 has an indention near where the catapult suppression stick 18 rests and is required so that the curly-Q loop 22, when attached to the catapult 20, comes to rest near the center of the catapult 20 and does not slide down the side of the catapult 20 when the trap is sprung, the swing arm actuator 14 is shaped for proper balance, which is necessary, so that it does not apply pressure to the catapult footplate 16 on its own, accidentally setting off the trap prematurely, the curly-Q loop 22 is shaped to be easily placed onto and removed from the catapult 20 without coming off during operation, the wire guide 34 position keeps the snare hoop 24 and the curly-Q loop 22 aligned properly with the platform 12, the snare hoop 24 has a hoop at the bottom end that includes a slipknot, which allows the circumference of the hoop to increase or decrease in size and the indention in the catapult footplate 16 nearest the SAA hole 36, keeps the swing arm actuator 14 from sliding off the catapult footplate 16.

In embodiments of the present invention, the springs force the catapult to transition from an open position, set by the user, to a closed position, to catch the animal. The catapult is connected to the springs at the base, and the distal end of the catapult (distant from the springs) has a snare coupling, such as a curly-Q loop, to pull on the snare. A suppression lever, such as a bar, releasably holds the catapult open, and a footplate releasably retains the suppression bar. The suppression lever and catapult are released when the animal engages with the actuator, thereby pressing down on the footplate.

It should be understood, of course, that the foregoing relates to exemplary embodiments of the invention and that modifications may be made without departing from the spirit and scope of the invention as set forth in the following claims.

I claim:

1. A device for catching an animal, comprising:
a spring to apply a rotational force;
a catapult attached to the spring, the catapult having an open position and a closed position, the catapult having a distal end from the spring,
the spring applying the rotational force to the catapult so that the distal end of the catapult rotates about the spring causing the catapult to transition from the open position to the closed position;
a snare for the animal having a size that reduces when the snare is pulled;
a snare coupling on the distal end of the catapult, attached to the snare so that when the catapult transitions from the open position to the closed position, the snare coupling pulls on the snare;
a suppression lever to releasably hold the catapult in the open position;
a footplate to releasably retain the suppression lever; and
an actuator to press upon the footplate in the presence of the animal;
wherein, in the presence of the animal, the actuator presses upon the footplate, which releases the suppression lever, which releases the catapult to transition from the open position to the closed position, which causes the snare coupling to pull on the snare, which reduces the size of the hoop, thereby catching the animal.

2. The device of claim 1, the snare including a first end connected to the snare coupling and a second end having a hoop with a diameter;
wherein when the actuator pulls on the first end of the snare, the diameter of the hoop at the second end is reduced to catch the animal.

3. The device of claim 1, further comprising:
a generally flat base;
wherein the distal end of the catapult is held adjacent a first side of the base when the catapult is in the open position, and the distal end of the catapult rotates to a second side of the base, opposite the first side, when the catapult transitions from the open position to the closed position.

4. The device of claim 1, further comprising:
a generally flat base, having a surface;
wherein a portion of the snare is adapted to extend beyond the surface of the base, a portion of the actuator is adapted to extend beyond the surface of the base, and the device is adapted to catch an animal located beyond the surface of the base.

5. The device of claim 1, further comprising:
a generally flat base; and
a second spring fixed to the base in a line with the spring, the spring and second spring cooperating to rotate the catapult; and
a space between the spring and second spring for the footplate to releasably retain the suppression lever in a line generally parallel to the base and perpendicular to the line of the springs.

6. The device of claim 1, further comprising:
a generally flat base having an aperture, a first side, and a second side,
wherein the actuator passes through the aperture, the actuator having a first end that extends beyond the first side of the base and presses down on the footplate, the actuator having a second end that extends beyond the second side of the base;
wherein, when an animal engages with the second end of the actuator, the actuator presses down on the footplate, thereby catching the animal.

7. A device for catching an animal in the ground, comprising:
a generally flat base;
a peg receptacle on two sides of the base, to releasably attach the base to the ground;
a catapult having an open position and a closed position;
a first spring, fixed to the base;
a second spring, fixed to the base, in a line with the first spring, the first and second springs adapted to apply a rotational force to the catapult that transitions the catapult from the open position to the closed position;
a suppression lever to releasably hold the catapult in the open position;
a footplate to releasably retain the suppression lever;
an actuator to press upon the footplate in the presence of the animal, a portion of the actuator adapted to extend into the ground;
a space between the first spring and second spring to allow the footplate and suppression lever to lie in a line generally parallel to the base and perpendicular to the line of the springs;
a snare for the animal having a size that reduces when the snare is pulled, a portion of the snare adapted to extend into the ground; and
a snare coupling that pulls on the snare when the catapult transitions from the open position to the closed position;
wherein, in the presence of the animal in the ground, the snare catches the animal.

8. A method of catching an animal, comprising:
in response to a presence of the animal, utilizing an actuator to press upon a footplate;
retaining and releasing a suppression lever with the footplate;
retaining and releasing a catapult with the suppression lever;
applying a rotational force to the catapult with a spring, thereby transitioning the catapult from an open position to a closed position;
when the catapult transitions from the open position to the closed position, pulling upon a coupling attached to the snare; and reducing a diameter of the snare, thereby catching the animal.

9. The method of claim 16, further comprising:
transitioning the catapult from the closed position to the open position by a user, and then transitioning the catapult from the open position to the closed position in the presence of the animal.

10. The method of claim 16, further comprising:
providing a snare having a diameter that is larger than a gopher; and
transitioning the snare to a diameter smaller than the size of a gopher;
thereby catching the gopher without killing the gopher.
